(19) United States
(12) Patent Application Publication
(10) Pub. No.: US 2026/0081542 A1
(43) Pub. Date: Mar. 19, 2026

(54) ROTOR, STATOR, AND ULTRASONIC MOTOR

(71) Applicant: Murata Manufacturing Co., Ltd., Nagaokakyo-shi (JP)

(72) Inventor: Hiroshi ASANO, Nagaokakyo-shi (JP)

(21) Appl. No.: 19/394,037

(22) Filed: Nov. 19, 2025

Related U.S. Application Data
(63) Continuation of application No. PCT/JP2024/035647, filed on Oct. 4, 2024.

(30) Foreign Application Priority Data
Mar. 21, 2024 (JP) 2024-045001

(51) Int. Cl. H02N 2/16

(52) U.S. Cl. CPC H02N 2/166

(57) ABSTRACT

A rotor for use in an ultrasonic motor, the rotor including: a rotor main body; and a sliding material on the rotor main body and positioned for contact with a vibrating body of a stator, the sliding material including carbon graphite. Also disclosed is a stator for an ultrasonic motor, the stator including: a vibrating body; a vibration generating element on the vibrating body; and a sliding material on the vibrating body and positioned for contact with a rotor, the sliding material including carbon graphite.

### CROSS REFERENCE TO RELATED APPLICATIONS

The present application is a continuation of International application No. PCT/JP2024/035647, filed October 4, 2024, which claims priority to Japanese Patent Application No. 2024-045001, filed March 21, 2004, the entire contents of each of which are incorporated herein by reference.

### TECHNICAL FIELD

The present disclosure relates to a rotor, a stator, and an ultrasonic motor.

### BACKGROUND ART

Conventionally, there have been proposed various ultrasonic motors in each of which a stator is vibrated by a piezoelectric element. Patent Document 1 below discloses one example of an ultrasonic motor. In this ultrasonic motor, the rotor is rotated by a traveling vibration wave generated in a stator.

The stator in Patent Document 1 is formed by bonding a ring-shaped piezoelectric body to a ring-shaped elastic body. Vibration of the piezoelectric body generates a traveling vibration wave in the elastic body. On the other hand, the rotor is formed by bonding a ring-shaped slider material to a ring-shaped rotor base material. The slider material in the rotor is in contact with the elastic body in the stator. When the rotor rotates, the slider material slides on the surface of the elastic body. The slider material in Patent Document 1 includes resin.

Patent Document 1: Japanese Patent Application Laid-Open No. H3-074182

### SUMMARY OF THE DISCLOSURE

When an ultrasonic motor using a slider material including resin is used in an environment with high humidity, there may be a case in which the rotor sticks to the stator, and the stator and the rotor are fixed to each other, and the ultrasonic motor cannot be started. This phenomenon is called “sticking”.

When the slider material including resin slides on the surface of the stator, there are generated abrasion powder finely crushed by mechanical friction and low molecular weight components decomposed by frictional heat, from the slider material. The present inventor has found that a low molecular weight component generated from the slider material contain a water-soluble components. The present inventor has found that when a water-soluble component or a mixture of a water-soluble component and abrasion powder is exposed to moisture and then dried, the stator and the rotor can be fixed to each other by exhibition of a function as an adhesive. This can cause sticking.

When sticking occurs, the ultrasonic motor cannot be started if a driving signal is applied. Therefore, the sticking causes a fatal failure of the ultrasonic motor.

An object of the present disclosure is to provide a rotor, a stator, and an ultrasonic motor capable of preventing sticking.

A rotor according to the present disclosure is a rotor for use in an ultrasonic motor, the rotor including: a rotor main body; and a sliding material on the rotor main body and positioned for contact with a vibrating body of a stator, wherein the sliding material includes carbon graphite.

A stator according to the present disclosure is a stator for use in an ultrasonic motor, the stator including: a vibrating body; a vibration generating element on the vibrating body; and a sliding material on the vibrating body and positioned for contact with a rotor, wherein the sliding material includes carbon graphite.

In a broad aspect of an ultrasonic motor according to the present disclosure, there are included: a rotor configured according to the present disclosure; and a stator including the vibrating body and the vibration generating element on the vibrating body.

In another broad aspect of an ultrasonic motor according to the present disclosure, there are included: a stator configured according to the present disclosure; and a rotor.

The rotor, the stator, and the ultrasonic motor according to the present disclosure makes it possible to prevent sticking.

### BRIEF EXPLANATION OF THE DRAWINGS

FIG. 1 is a schematic front sectional view of an ultrasonic motor according to a first embodiment of the present disclosure.

FIG. 2 is a schematic plan view of a stator according to the first embodiment of the present disclosure.

FIG. 3 is a schematic plan view of a rotor according to the first embodiment of the present disclosure.

FIG. 4 is a schematic sectional view taken along line I-I in FIG. 3.

FIG. 5 is a schematic front sectional view of a piezoelectric element according to the first embodiment of the present disclosure.

FIG. 6 is a schematic plan view of a rotor according to a second embodiment of the present disclosure.

FIG. 7 is a schematic plan view of a rotor according to a third embodiment of the present disclosure.

FIG. 8 is a schematic plan view of a rotor according to a modification of the third embodiment of the present disclosure.

FIG. 9 is a schematic sectional view illustrating a portion corresponding to a section taken along line I-I in FIG. 3 of a rotor according to a fourth embodiment of the present disclosure.

FIG. 10 is a schematic sectional view illustrating a state in which: a portion illustrated in FIG. 9 of a rotor according to the fourth embodiment of the present disclosure is in contact with a vibrating body of a stator; and a traveling wave is generated in the stator.

FIG. 11 is a schematic sectional view illustrating a portion corresponding to a section taken along line I-I in FIG. 3 of a rotor according to a modification of the fourth embodiment of the present disclosure.

FIG. 12 is a schematic bottom view of a stator according to a fifth embodiment of the present disclosure.

FIG. 13 is a schematic bottom view of a stator according to a sixth embodiment of the present disclosure.

FIG. 14 is a schematic sectional view taken along line II-II in FIG. 13.

### DESCRIPTION OF THE PREFERRED EMBODIMENTS

Hereinafter, the present disclosure will be clarified by describing specific embodiments of the present disclosure with reference to the drawings.

Note that each of the embodiments described in the present description is an exemplary embodiment, and replacement of some part or combination of configurations is possible among different embodiments.

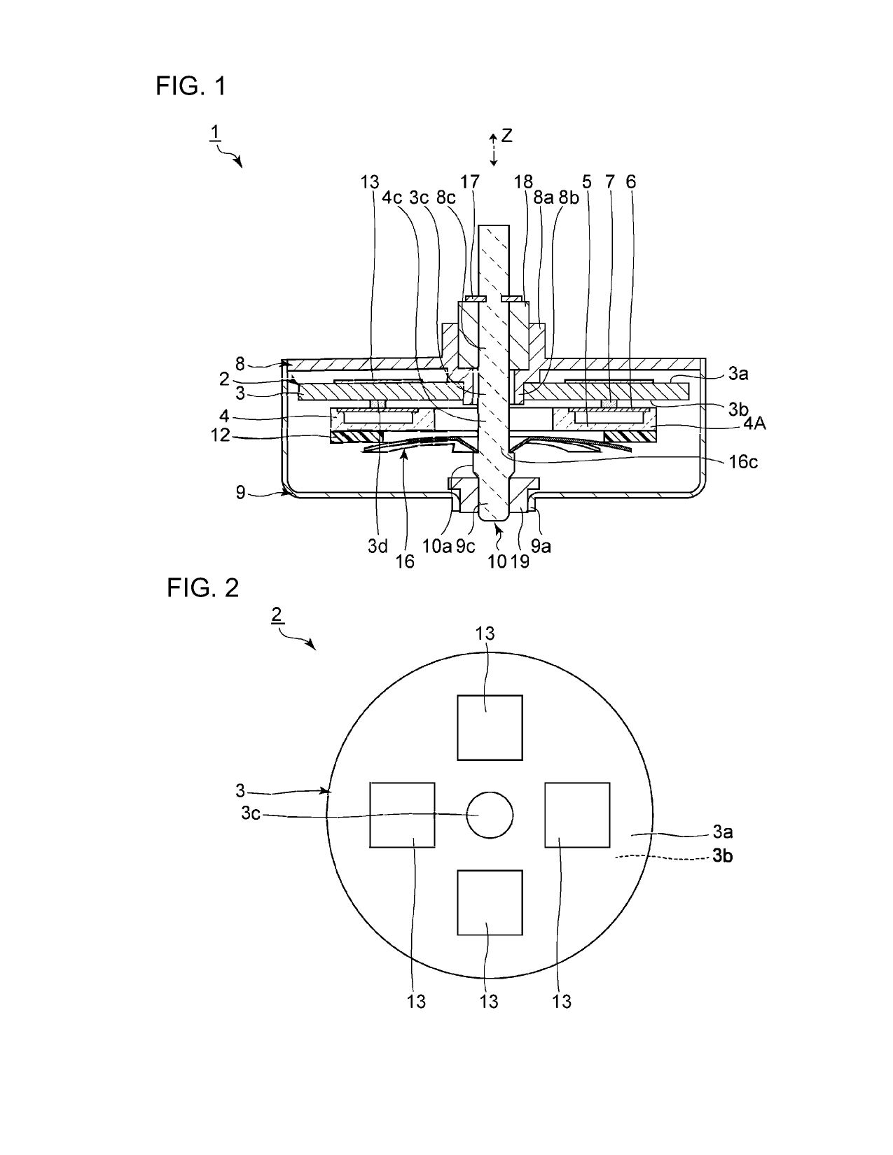

FIG. 1 is a schematic front sectional view of an ultrasonic motor according to a first embodiment of the present disclosure.

The ultrasonic motor 1 includes a stator 2, a rotor 4, and a shaft member 10. The stator 2 and the rotor 4 are in contact with each other. The rotor 4 is a rotor according to an embodiment of the present disclosure. The rotor 4 is rotated by a traveling wave generated in the stator 2. As the rotor 4 rotates, the shaft member 10 rotates. The rotation central axis of the ultrasonic motor 1 is located at a portion where the shaft member 10 is provided. Hereinafter, a specific configuration of the ultrasonic motor 1 will be described.

FIG. 2 is a schematic plan view of the stator of the first embodiment.

The stator 2 includes a plate-shaped vibrating body 3. The vibrating body 3 has a disk shape. The vibrating body 3 has a first main surface 3a and a second main surface 3b. The first main surface 3a and the second main surface 3b face each other.

A through hole 3c is provided in a central portion of the vibrating body 3. As illustrated in FIG. 1, the shaft member 10 is inserted into the through hole 3c. The position of the through hole 3c is not limited to the central portion of the vibrating body 3. The through hole 3c may be located in a region including the rotation central axis. Further, the shape of the vibrating body 3 is not limited to a disk shape.

In the present description, an axial direction Z is a direction along which the first main surface 3a and the second main surface 3b are connected, and is a direction along a rotation central axis. In the present embodiment, the axial direction Z is parallel to the direction in which the shaft member 10 extends. The shape of the vibrating body 3 viewed from the axial direction Z may be a regular polygon such as a regular hexagon, a regular octagon, or a regular decagon. In the present description, a polygon includes a case where a portion corresponding to a vertex has a curved shape and a case where the portion has a chamfered shape. Hereinafter, viewing from the axial direction Z may be referred to as plan view.

The vibrating body 3 includes an appropriate metal. However, the vibrating body 3 is not necessarily made of metal. The vibrating body 3 may include another elastic body such as ceramics, or a silicon material.

As illustrated in FIG. 2, a plurality of piezoelectric elements 13 are provided on the first main surface 3a of the vibrating body 3. The piezoelectric elements 13 are vibration generating elements in the present disclosure. In plan view, the plurality of piezoelectric elements 13 are dispersedly disposed in the circling direction. More specifically, the plurality of piezoelectric elements 13 are dispersedly disposed in a circling direction of a traveling wave so as to generate the traveling wave that circles around an axis parallel to the axial direction Z. For example, WO 2010/061508 A discloses a structure in which the stator 2 has the plurality of piezoelectric elements 13 dispersedly disposed in the circling direction and drives the elements 13 to generate a traveling wave. Therefore, a detailed description of the generation of the traveling wave will be omitted.

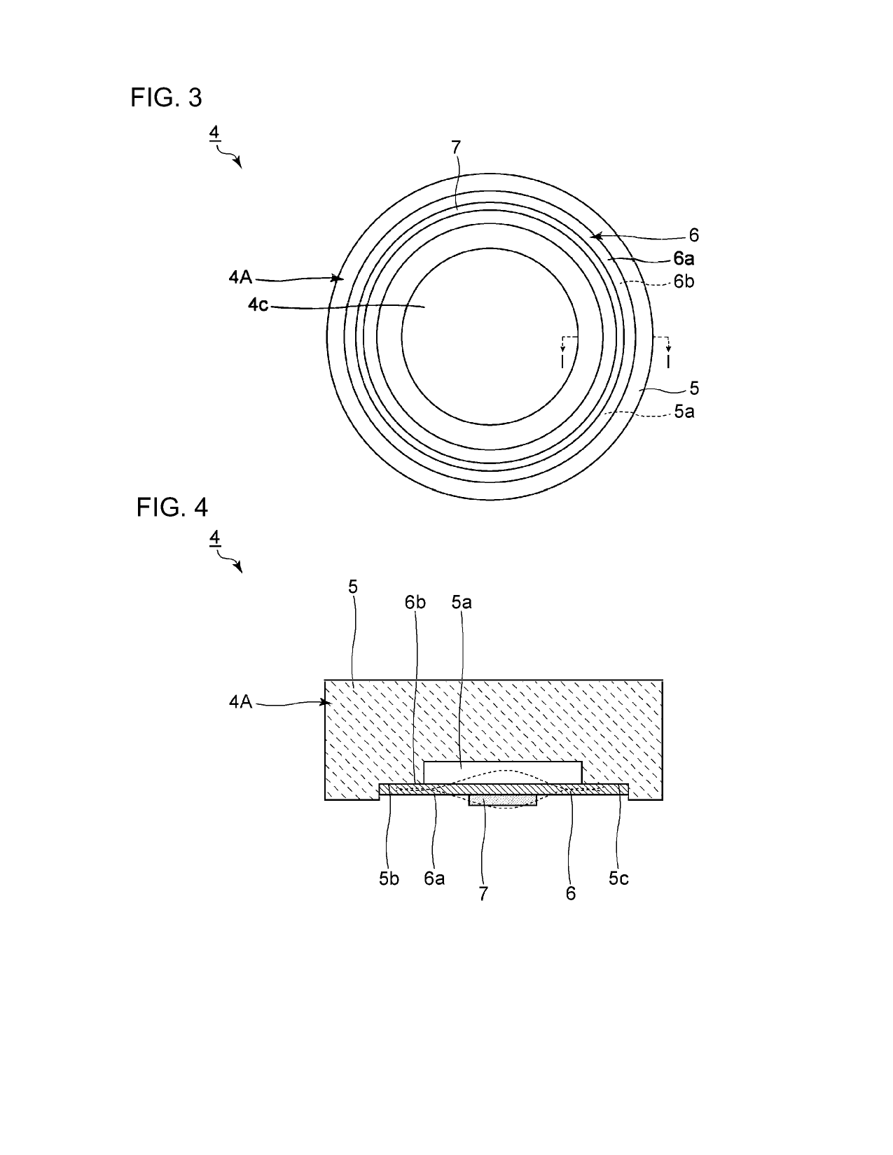

FIG. 3 is a schematic plan view of the rotor according to the first embodiment.

The rotor 4 includes a rotor main body 4A and a sliding material 7. The rotor main body 4A has a circular shape in plan view. A through hole 4c is provided in a central portion of the rotor main body 4A. The shaft member 10 illustrated in FIG. 1 is inserted into the through hole 4c. However, the position of the through hole 4c is not limited to the central portion of the rotor main body 4A. The through hole 4c only needs to be located in a region including the rotation central axis. Further, the shape of the rotor main body 4A is not limited to the above. The outer shape of the rotor main body 4A in a plan view may be, for example, a regular polygon such as a regular hexagon, a regular octagon, or a regular decagon.

The sliding material 7 is provided on the rotor main body 4A. The sliding material 7 has a circular shape in plan view. The sliding material 7 is provided so as to surround the through hole 4c of the rotor main body 4A. The sliding material 7 is a member that comes into contact with the stator 2 illustrated in FIG. 1. In the present embodiment, specifically, the sliding material 7 is in contact with the vibrating body 3 in the stator 2. When the ultrasonic motor 1 is driven to rotate the rotor 4, the sliding material 7 in the rotor 4 slides on the surface of the vibrating body 3 in the stator 2.

The sliding material 7 includes carbon graphite. The carbon graphite refers to a carbon-based material having a graphitization degree R = D/G of 0.5 to 1.2. More specifically, the peak value of the D band in a Raman spectrum of the carbon graphite obtained by Raman spectroscopy is D. The peak value of the G band in the Raman spectrum is G. Note that the D band is a band around 1360 cm⁻¹ in the Raman spectrum. Note that the G band is a band around 1580 cm⁻¹ in the Raman spectrum. The graphitization degree R of the carbon graphite is a value obtained by dividing the peak value D by the peak value G.

When the graphitization degree R in the present description is calculated, a Raman spectrum of the carbon graphite used for the sliding material is obtained by Raman spectroscopy in which the wavelength of incident laser light is 532 nm and a grating type is 600 gr/m. Next, the peak value D and the peak value G in the obtained Raman spectrum are obtained. Next, R = D/G is calculated using the obtained peak value D and peak value G.

In addition, the peak value D and the peak value G is obtained preferably after smoothing the Raman spectrum with the Savizky-Golay-2nd filter.

When the graphitization degree R of the carbon graphite constituting the sliding material 7 is too high, the lubricity of the sliding material 7 may be lowered. Conversely, when the graphitization degree R of the carbon graphite constituting the sliding material 7 is too low, the wear resistance of the sliding material 7 may be lowered.

When the carbon graphite is obtained that constitutes the sliding material 7, for example, a carbon solid is obtained by solidifying carbon powder by compression molding or the like. Thereafter, heat treatment of the carbon solid is performed to advance crystallization of a part of the carbon solid. In other words, a part of the carbon solid is changed from carbonaceous to graphitic. Thereby, a carbon graphite is obtained. However, the carbon graphite is obtained by crystallizing a part of a carbon solid, and the carbon graphite is a kind of amorphous carbon.

As illustrated in FIG. 3, the rotor main body 4A includes a rotor base portion 5 and a leaf spring portion 6. The outer shape of the rotor main body 4A in plan view is the outer shape of the rotor base portion 5 in plan view. The through hole 4c of the rotor main body 4A is provided in the rotor base portion 5. On the other hand, the leaf spring portion 6 has a circular shape in plan view. The leaf spring portion 6 is provided so as to surround the through hole 4c. A material of the rotor base portion 5 to be used can be an appropriate metal, an appropriate ceramic, or the like. A material of the leaf spring portion 6 to be used can be an appropriate metal or the like.

FIG. 4 is a schematic sectional view taken along line I-I in FIG. 3. A broken line in FIG. 4 schematically indicates displacement of a leaf spring portion to be described later.

The rotor base portion 5 has a recessed portion 5a. Although not illustrated, the shape of the recessed portion 5a in plan view is a circular shape. The leaf spring portion 6 is provided on the rotor base portion 5 so as to cover the recessed portion 5a. The leaf spring portion 6 has a first surface 6a and a second surface 6b. The first surface 6a and the second surface 6b face each other. Of the first surface 6a and the second surface 6b, the first surface 6a is located on the stator 2 side illustrated in FIG. 1.

The sliding material 7 is provided on the leaf spring portion 6 in the rotor main body 4A. In the present description, a case in which a certain member has another member provided thereon includes a case in which a certain member has another member provided directly thereon and a case in which a certain member has another member provided indirectly thereon with another layer or the like interposed therebetween. In the present embodiment, the sliding material 7 is directly provided on the leaf spring portion 6. The sliding material 7 may be bonded to the leaf spring portion 6 by a bonding member such as an adhesive.

The entire sliding material 7 is included within the recessed portion 5a of the rotor base portion 5 in plan view. The width of the sliding material 7 is narrower than the width of the leaf spring portion 6 and the width of the recessed portion 5a. The width of the sliding material 7 in the present embodiment is a distance between an inner peripheral edge and an outer peripheral edge of the sliding material 7 in plan view. The same applies to the width of the leaf spring portion 6 and the width of the recessed portion 5a.

Returning to FIG. 3, the feature of the present embodiment is that the sliding material 7 is provided on the rotor main body 4A in the rotor 4, and the sliding material 7 incudes carbon graphite. As a result, if the ultrasonic motor 1 using the rotor 4 is used in an environment with high humidity or the like, sticking can be prevented. The sticking refers to a phenomenon in which the rotor sticks to the stator, the stator and the rotor are fixed to each other, and the ultrasonic motor cannot be started. Hereinafter, details of the above effect will be described.

When the ultrasonic motor 1 illustrated in FIG. 1 is driven, the sliding material 7 in the rotor 4 slides on the surface of the vibrating body 3 in the stator 2. At this time, if abrasion powder is generated from the sliding material 7 including carbon graphite, a water-soluble component that functions as an adhesive is not generated. Therefore, also in an environment in which the humidity is high and the rotor 4 and the stator 2 are exposed to moisture, the portion of the ultrasonic motor 1 where the rotor 4 and the stator 2 are in contact with each other is less likely to be solidified. This makes it possible to prevent sticking. As a result, the ultrasonic motor 1 can be suitably used also in a severe environment with high humidity.

As illustrated in FIG. 4, it is preferable that the rotor base portion 5 have a recessed portion 5a, and the leaf spring portion 6 be provided on the rotor base portion 5 so as to cover the recessed portion 5a. The sliding material 7 is preferably provided on the leaf spring portion 6. Accordingly, the rotor 4 can be efficiently rotated. Hereinafter, this will be described.

In the stator 2 illustrated in FIG. 1, the vibration of the piezoelectric elements 13 serving as vibration generating elements displaces the vibrating body 3, and generates a traveling wave. When a traveling wave is generated, a part displaced large and a part displaced small are generated in the vibrating body 3. More specifically, when a traveling wave is generated, the displacement is largest at the part of the wave head of the traveling wave in vibrating body 3. The displacement is also large in a peripheral part of the wave head in the vibrating body 3. When a contact area between a largely displaced part of the vibrating body 3 and the rotor 4 is large, the rotor 4 can be efficiently rotated.

Here, in the present embodiment, as illustrated in FIG. 4, the sliding material 7 is provided on the leaf spring portion 6. Therefore, the leaf spring portion 6 elastically deforms as indicated by a broken line in FIG. 4 following displacement of vibrating body 3 due to the traveling wave. As a result, when a traveling wave is generated, the part of the wave head in the vibrating body 3 and the peripheral part thereof can be brought into contact with the sliding material 7. This makes it possible to increase the area of contact between the largely displaced part of the vibrating body 3 and the sliding material 7 in the rotor 4. Therefore, the frictional force can be increased between the vibrating body 3 and the rotor 4, and the rotor 4 can be efficiently rotated.

The configuration, in which the rotor base portion 5 has the recessed portion 5a and the leaf spring portion 6 is provided on the rotor base portion 5 so as to cover the recessed portion 5a, can also be applied to the configuration of the present disclosure other than the present embodiment. However, in the present disclosure, the rotor main body 4A does not necessarily have the leaf spring portion 6. The rotor base portion 5 does not necessarily have the recessed portion 5a. The sliding material 7 may be provided on the rotor main body 4A so as to be in contact with the stator 2.

Hereinafter, the configuration of the present embodiment will be described in more detail.

As illustrated in FIG. 1, the ultrasonic motor 1 includes a first case member 8 and a second case member 9. The second case member 9 has a cap shape, and the first case member 8 has a lid shape. The first case member 8 and the second case member 9 constitute a case. The spring member 16, the rotor 4, and the stator 2 are disposed inside the case.

The first case member 8 has a first cylindrical protruding portion 8a and a second cylindrical protruding portion 8b. The first cylindrical protruding portion 8a protrudes to the outside of the case. The second cylindrical protruding portion 8b protrudes to the inside of the case. A part of the second cylindrical protruding portion 8b is located in the through hole 3c of the vibrating body 3 of the stator 2.

The first cylindrical protruding portion 8a and the second cylindrical protruding portion 8b are continuously provided with a through hole 8c. A first bearing portion 18 is provided in the through hole 8c at a portion located in the first cylindrical protruding portion 8a. The shaft member 10 is inserted through the through hole 8c and the first bearing portion 18. The shaft member 10 protrudes from the through hole 8c of the first case member 8 to the outside of the case. Note that the configuration of the first case member 8 is not limited to the above.

The second case member 9 has a cylindrical protruding portion 9a. The cylindrical protruding portion 9a protrudes to the outside of the case. The cylindrical protruding portion 9a is provided with a through hole 9c. A second bearing portion 19 is provided in the through hole 9c. The shaft member 10 is inserted through the through hole 9c and the second bearing portion 19. The shaft member 10 protrudes from the through hole 9c of the second case member 9 to the outside of the case. Note that the configuration of the second case member 9 is not limited to the above. For example, a sliding bearing or a bearing may be used for each of the first bearing portion 18 and the second bearing portion 19.

The sliding material 7 of the rotor 4 is in contact with the second main surface 3b of the vibrating body 3 in the stator 2. The second main surface 3b includes a contact surface 3d. The contact surface 3d is a portion of the second main surface 3b in contact with the rotor 4. The contact surface 3d has a planar shape. More specifically, the contact surface 3d is not provided with an uneven structure. The contact surface 3d is configured similarly to the portion of the second main surface 3b other than the contact surface 3d. Therefore, when the stator 2 of the present embodiment is obtained, it is not necessary to cut the second main surface 3b of the vibrating body 3. Therefore, productivity of the ultrasonic motor 1 can be enhanced.

An elastic member 12 is provided on the rotor base portion 5 of the rotor 4. More specifically, the elastic member 12 together with the stator 2 sandwiches the rotor 4 in the axial direction Z. The elastic member 12 has a circular shape. Note that the shape of the elastic member 12 is not limited to the above. A material of the elastic member 12 to be used can be, for example, rubber or resin. However, the elastic member 12 may not be provided.

The spring member 16 is disposed on the second bearing portion 19 side of the elastic member 12. Specifically, the spring member 16 of the present embodiment is a leaf spring including metal. A through hole 16c is provided in a central portion of the spring member 16. The shaft member 10 is inserted through the through hole 16c. The shaft member 10 has a wide portion 10a. The width of the wide portion 10a of the shaft member 10 is wider than the width of the other portion of the shaft member 10. Note that the width of the shaft member 10 is a dimension in a direction orthogonal to the axial direction Z of the shaft member 10. An inner peripheral end edge portion of the spring member 16 is in contact with the wide portion 10a. This can prevent misalignment between the spring member 16 and the shaft member 10. However, the material and configuration of the spring member 16 are not limited to the above. The configuration of the shaft member 10 is also not limited to the above.

An elastic force is applied from the spring member 16 to the rotor 4 with the elastic member 12 interposed therebetween. As a result, the rotor 4 is pressed against the stator 2. In this case, frictional force between the stator 2 and the rotor 4 can be increased. Thus, the traveling wave can be effectively propagated from the stator 2 to the rotor 4, and the rotor 4 can be efficiently rotated. Therefore, the ultrasonic motor 1 can be more reliably and efficiently driven.

As illustrated in FIG. 1, the shaft member 10 is provided with a snap ring 17. The snap ring 17 has a circular shape. In plan view, the snap ring 17 surrounds the shaft member 10. More specifically, an inner peripheral end edge portion of the snap ring 17 is located in the shaft member 10. The snap ring 17 is in contact with the first bearing portion 18 from the outside in the axial direction Z. This defines the length between the snap ring 17 and the wide portion 10a of the shaft member 10, and determines the amount of deflection of the spring member 16. As a result, as described above, the elastic force by the spring member 16 can be applied to the rotor 4. The material of the shaft member 10 and the snap ring 17 to be used can be, for example, metal or resin.

As illustrated in FIG. 2, the stator 2 includes a plurality of piezoelectric elements 13. Hereinafter, a specific configuration of each piezoelectric element 13 will be described.

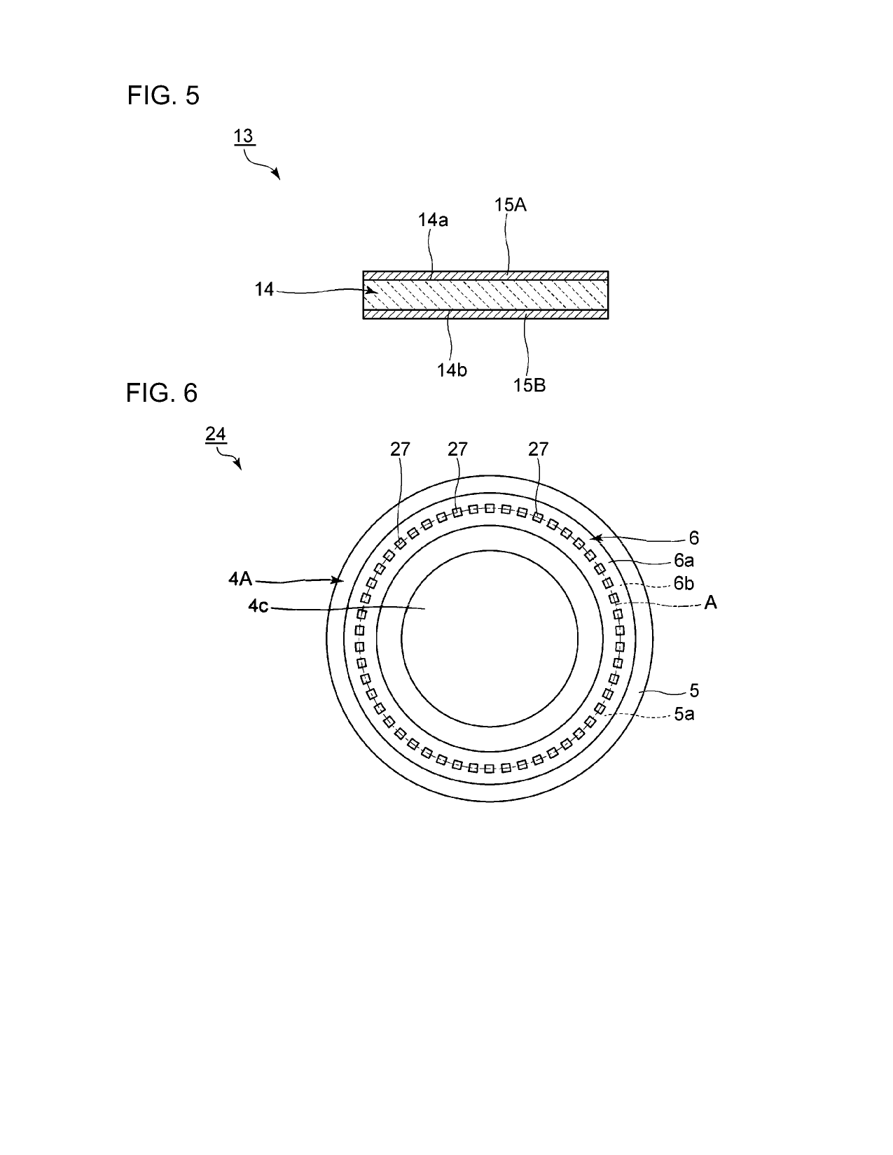

FIG. 5 is a schematic front sectional view of the piezoelectric element according to the first embodiment.

The piezoelectric element 13 includes a piezoelectric body 14. The piezoelectric body 14 has a third main surface 14a and a fourth main surface 14b. The third main surface 14a and the fourth main surface 14b face each other. The piezoelectric element 13 includes a first electrode 15A and a second electrode 15B. The first electrode 15A is provided at the third main surface 14a of the piezoelectric body 14, and the second electrode 15B is provided at the fourth main surface 14b thereof. The shape of the piezoelectric element 13 in plan view is rectangular. The shape of the piezoelectric element 13 in plan view is not limited to the above, and may be, for example, an elliptical shape.

In the present embodiment, the stator 2 includes four piezoelectric elements 13. Note that the number of the piezoelectric elements 13 is not limited to the above. The plurality of piezoelectric elements 13 only need to be dispersedly disposed in the circling direction of a traveling wave so as to generate the traveling wave that circles around an axis parallel to the axial direction Z.

Alternatively, the stator 2 may include one piezoelectric element divided into a plurality of regions. In this case, for example, the regions of the piezoelectric element may be polarized in different directions from each other. The shape of the piezoelectric element in plan view is, for example, a circular shape.

Here, the first electrode 15A illustrated in FIG. 5 is attached to the first main surface 3a of the vibrating body 3 with an adhesive. The thickness of this adhesive is very thin. Therefore, the first electrode 15A is electrically connected to the vibrating body 3.

As illustrated in FIG. 4, the rotor base portion 5 is provided with a groove portion 5b so as to be connected to the inner peripheral edge of the recessed portion 5a. Similarly, the rotor base portion 5 is provided with a groove portion 5c so as to be connected to the outer peripheral edge of the recessed portion 5a. The groove portion 5b and the groove portion 5c each have a circular shape in plan view. The leaf spring portion 6 is provided from the groove portion 5b to the groove portion 5c. More specifically, the inner peripheral edge of the leaf spring portion 6 is located in the groove portion 5b. The outer peripheral edge of the leaf spring portion 6 is located in the groove portion 5c.

In this case, in a state in which the thickness of the leaf spring portion 6 is set to a desired thickness, there can be reduced the thickness of the portion where the leaf spring portion 6 protrudes from the rotor base portion 5 in the axial direction Z. Alternatively, when the dimension corresponding to the depth of the groove portion 5b and the groove portion 5c is equal to or larger than the dimension corresponding to the thickness of the leaf spring portion 6, the leaf spring portion 6 can be configured not to protrude from the rotor base portion 5 in the axial direction Z. As a result, the leaf spring portion 6 is not likely to be peeled off from the rotor base portion 5.

In the present embodiment, the rotor base portion 5 having the groove portion 5b and the groove portion 5c and the leaf spring portion 6 are fitted to each other. In this case, the leaf spring portion 6 is easily positioned in forming the rotor 4. Therefore, the rotor 4 can be efficiently obtained, and the productivity of the ultrasonic motor 1 can be effectively enhanced. Note that the groove portion 5b and the groove portion 5c are not necessarily provided.

The ultrasonic motor 1 of the present embodiment illustrated in FIG. 1 is an example, and the configuration of the ultrasonic motor 1 is not limited to the above. Similarly, the configuration of the stator 2 is not limited to the above. The stator 2 only needs to have an appropriate vibrating body 3 and a vibration generating element provided on the vibrating body 3. In the rotor 4 according to the present disclosure, the sliding material 7 only needs to be provided so as to be in contact with the vibrating body 3 of the stator 2.

FIG. 6 is a schematic plan view of a rotor according to a second embodiment of the present disclosure. In FIG. 6, an annular track A is indicated by a dash-dotted line.

The rotor 24 of the present embodiment is different from the rotor 4 of the first embodiment in including a plurality of sliding materials 27. The plurality of sliding materials 27 are dispersedly disposed in an annular track A in a plan view of the rotor. For points other than the above, the rotor 24 of the present embodiment has the same configuration as the rotor 4 of the first embodiment.

In the present embodiment, the annular track A is a circular track. The annular track A corresponds to a track along the circling direction of the traveling wave generated in the stator used in the ultrasonic motor together with the rotor 24. Therefore, the plurality of sliding materials 27 are dispersedly disposed in the circling direction of the traveling wave.

Since the plurality of sliding materials 27 are dispersedly disposed as described above, the rotor 24 can have a lower rigidity in the circling direction of the traveling wave. As a result, when a traveling wave is generated in the stator used together with the rotor 24, the leaf spring portion 6 can be made likely to effectively follow the displacement of the vibrating body of the stator. As a result, when a traveling wave is generated, the part of the wave head in the vibrating body and the peripheral part thereof can be more reliably brought into contact with the sliding materials 27. This makes it possible to increase the area of contact between the largely displaced part of the vibrating body and the sliding materials 27 in the rotor 24. Therefore, the frictional force can be increased between the vibrating body and the rotor 24, and the rotor 24 can be more reliably and efficiently rotated.

In addition, the plurality of sliding materials 27 include carbon graphite. Accordingly, also in the present embodiment, the sticking can be prevented similarly to the first embodiment.

Each sliding material 27 is preferably disposed such that the center of gravity of the sliding material 27 is positioned on the annular track A. Accordingly, when the rotor 24 is used in the ultrasonic motor, the ultrasonic motor can be more reliably and stably driven. Here, the sliding material 27 can be used if any part thereof is located on the annular track A. The center of gravity of the sliding material 27 is not necessarily located on the annular track A.

As in the first embodiment, the width of each sliding material 27 is narrower than the width of the leaf spring portion 6 and the width of the recessed portion 5a in the rotor base portion 5. The width of the sliding material 27 in the present embodiment is a dimension in a direction orthogonal to the annular track A of the sliding material 27 in plan view.

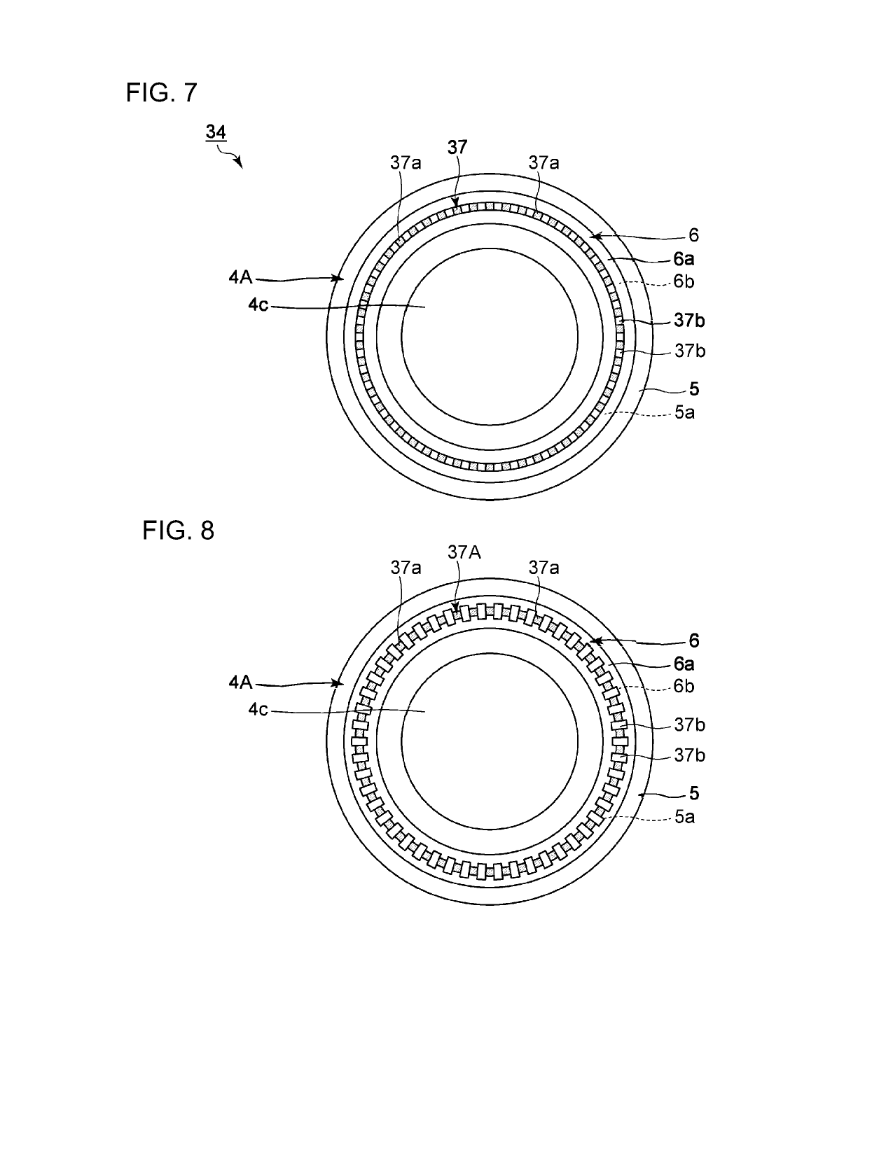

FIG. 7 is a schematic plan view of a rotor according to a third embodiment. In FIG. 7, protruding portions of the sliding material described later are hatched.

The rotor 34 of the present embodiment is different from the rotor 4 of the first embodiment in that the sliding material 37 has a plurality of protruding portions 37a. For points other than the above, the rotor 34 of the present embodiment has the same configuration as the rotor 4 of the first embodiment.

The sliding material 37 has a circular shape in plan view. The plurality of protruding portions 37a of the sliding material 37 are dispersedly disposed in an annular track. In other words, the plurality of protruding portions 37a are dispersedly disposed in the circling direction of the traveling wave generated in the stator used together with the rotor 34 in the ultrasonic motor. The plurality of protruding portions 37a protrude outward in the axial direction Z from the rotor main body 4A side. Therefore, the plurality of protruding portions 37a protrude toward the vibrating body of the stator. The plurality of protruding portions 37a of the sliding material 37 are in contact with the vibrating body.

In the sliding material 37, the plurality of protruding portions 37a are connected to each other by a portion other than the protruding portions 37a. More specifically, the sliding material 37 has a plurality of protruding portions 37a and a plurality of non-protruding portions 37b. The thickness of a non-protruding portion 37b is thinner than the thickness of a protruding portion 37a. The adjacent protruding portions 37a are connected by the non-protruding portions 37b. The sliding material 37 is configured such that portions in contact with the vibrating body of the stator and portions thinner than the portions are alternately provided in the circling direction of the traveling wave generated in the stator used together with the rotor 34. This configuration can reduce the rigidity of the rotor 34 in the circling direction of the traveling wave.

As a result, when a traveling wave is generated in the stator used together with the rotor 34, the leaf spring portion 6 can be made likely to effectively follow the displacement of the vibrating body of the stator. As a result, when a traveling wave is generated, the part of the wave head in the vibrating body and the peripheral part thereof can be more reliably brought into contact with the sliding material 37. This makes it possible to increase the area of contact between the largely displaced part of the vibrating body and the sliding material 37 in the rotor 34. Therefore, the frictional force can be increased between the vibrating body and the rotor 34, and the rotor 34 can be more reliably and efficiently rotated.

The sliding material 37 in the present embodiment corresponds to one member in which the plurality of sliding materials 27 in the second embodiment are connected. Specifically, the sliding material 37 has portions corresponding to the plurality of sliding materials 27, and the portions are the plurality of protruding portions 37a. Since the sliding material 37 is one member having the above configuration, the sliding material 37 is easily handled, and the rotor 34 is easily processed and assembled. Accordingly, the productivity of the rotor 34 can be increased. Further, this can increase the strength of the connection between the sliding material 37 and the leaf spring portion 6 of the rotor main body 4A.

The thickness of the portion other than the protruding portions 37a in the sliding material 37, that is, the thickness of a non-protruding portion 37b is preferably 70% or less of the thickness of a protruding portion 37a, and more preferably 30% or less. This makes it possible to more reliably reduce the rigidity of the rotor 34 in the circling direction of the traveling wave.

In addition, the sliding material 37 includes carbon graphite. As a result, sticking can be prevented as in the first embodiment.

In the sliding material 37, the width of a protruding portion 37a is the same as the width of a non-protruding portion 37b. However, the present disclosure is not limited thereto. For example, in the modification of the third embodiment illustrated in FIG. 8, the sliding material 37A has the non-protruding portions 37b each having a width wider than the width of a protruding portion 37a. Since the width of the non-protruding portion 37b is wide, it is possible to effectively increase the strength of connection between the sliding material 37A and the leaf spring portion 6 in the rotor main body 4A.

The sliding material 37A includes carbon graphite. As a result, sticking can be prevented as in the third embodiment.

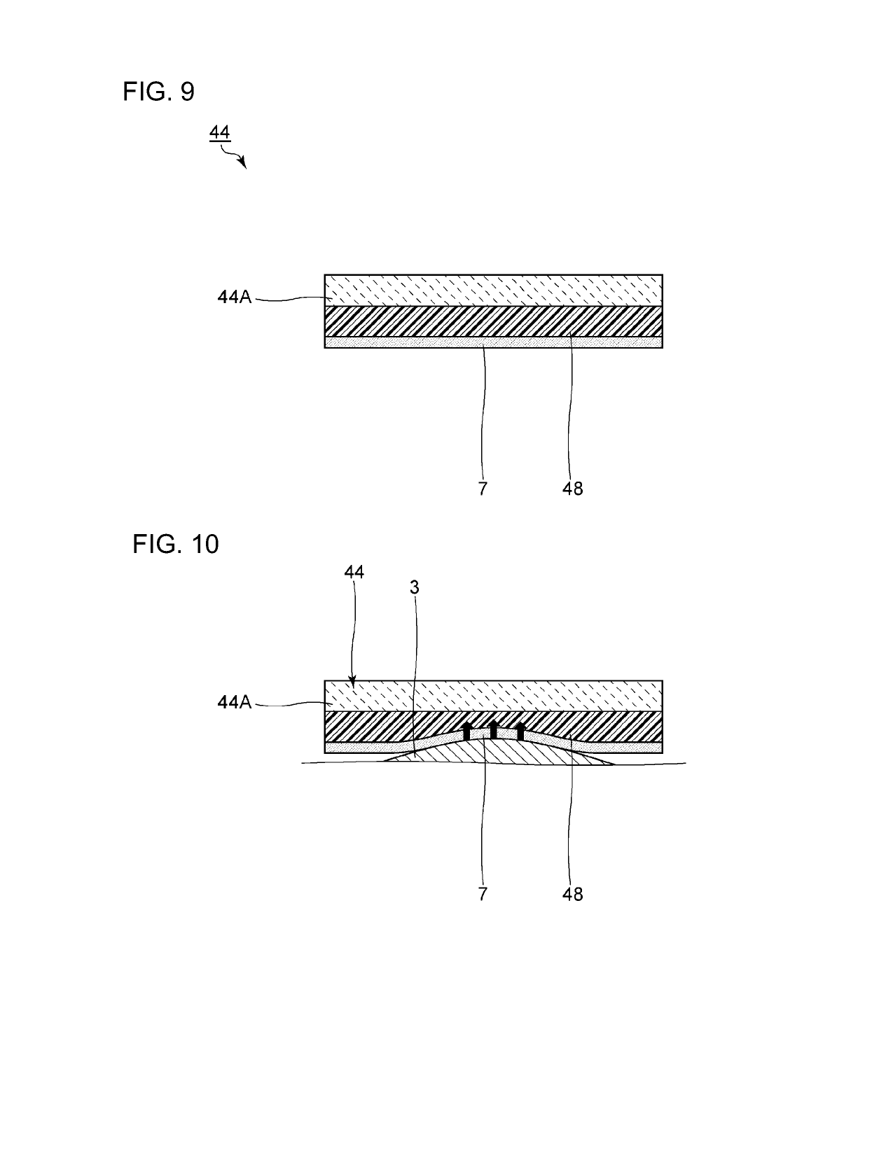

FIG. 9 is a schematic sectional view illustrating a portion corresponding to a section taken along line I-I in FIG. 3 of the rotor according to a fourth embodiment.

A rotor 44 of the present embodiment is different from the rotor 4 of the first embodiment in that the rotor main body 44A consists of only a rotor base portion and the rotor base portion does not have a recessed portion. In other words, the rotor 44 does not have a leaf spring portion. The rotor 44 of the present embodiment is different from the rotor 4 of the first embodiment also in including a soft resin layer 48. Further, the rotor 44 of the present embodiment is different from the rotor 4 of the first embodiment also in that the width of the sliding material 7 is the same as the width of the rotor main body 44A. For points other than the above, the rotor 44 of the present embodiment has the same configuration as the rotor 4 of the first embodiment.

In the present description, the soft resin layer 48 refers to a resin layer in which at least one of Young's modulus and bending elastic modulus is relatively low. Specifically, the Young's modulus of the soft resin layer 48 is preferably 80% or less of the Young's modulus of the sliding material 7, or the bending elastic modulus of the soft resin layer 48 is preferably 80% or less of the bending elastic modulus of the sliding material 7.

For soft resin layer 48, for example, an epoxy resin, a phenol resin, or a polyphenylene sulfide (PPS) resin can be used. Alternatively, the soft resin layer 48 may be a resin layer in which the Young's modulus is adjusted to 80% or less of the Young's modulus of the sliding material 7 or the bending elastic modulus is adjusted to 80% or less of the bending elastic modulus of the sliding material 7 by adding an additive to an appropriate resin. Alternatively, the soft resin layer 48 may be a resin layer in which at least one of the Young's modulus and the bending elastic modulus is adjusted to 7 GPa or less by adding an additive to an appropriate resin.

The soft resin layer 48 is provided between the rotor main body 44A and the sliding material 7. In other words, the rotor 44 has a configuration in which the rotor main body 44A, the soft resin layer 48, and the sliding material 7 are laminated in this order.

More specifically, in the present embodiment, the entire portion of the sliding material 7 is provided on the soft resin layer 48. Note that the sliding material 7 may include a portion not provided on the soft resin layer 48. The rotor 44 is used for an ultrasonic motor together with a stator having a vibrating body. The portion where the sliding material 7 and the soft resin layer 48 are laminated only needs to overlap the part of the wave head in the vibrating body and the peripheral part thereof when a traveling wave is generated in the stator in plan view.

Soft resin layer 48 and sliding material 7 may be bonded to each other by a bonding member such as a separate adhesive. Alternatively, the soft resin layer 48 may be a bonding member that bonds the rotor main body 44A and the sliding material 7.

As described above, the width of the sliding material 7 is the same as the width of the rotor main body 44A. However, for example, the width of the sliding material 7 may be narrower than the width of the rotor main body 44A.

FIG. 10 is a schematic sectional view illustrating a state in which the portion illustrated in FIG. 9 of the rotor according to the fourth embodiment is in contact with the vibrating body of the stator and a traveling wave is generated in the stator.

In the present embodiment, a part of the rotor 44 is elastically deformed following the displacement of the vibrating body 3 due to the traveling wave. More specifically, the soft resin layer 48 is elastically deformed. Accordingly, the sliding material 7 is also deformed as indicated by arrows in FIG. 10. As a result, when a traveling wave is generated, the part of the wave head in the vibrating body 3 and the peripheral part thereof can be brought into contact with the sliding material 7. This makes it possible to increase the area of contact between the largely displaced part of the vibrating body 3 and the sliding material 7 in the rotor 44. Therefore, the frictional force can be increased between the vibrating body 3 and the rotor 44, and the rotor 44 can be more reliably and efficiently rotated.

As the soft resin layer 48 is elastically deformed following the displacement of the vibrating body 3 in the stator, the resonance state of the stator changes. Specifically, a part of energy of vibration in the stator is converted into heat as the soft resin layer 48 is elastically deformed. In other words, the energy of vibration in the stator is absorbed. This reduces the mechanical quality factor Qm of the resonance state of the stator, and reduces the amplitude of the vibrating body 3 in the stator. Note that the maximum rotation speed of the ultrasonic motor increases as the amplitude of the vibrating body 3 increases. On the other hand, an effect can be obtained that widens the range of frequencies at which the stator is in the resonance state as the soft resin layer 48 is elastically deformed. This effect is called a damping effect.

The damping effect can cause the stator to be likely to come into a resonance state if the vibration of the stator varies. Therefore, if the vibration of the stator varies, the rotor 44 can be suitably rotated, and the ultrasonic motor can be suitably driven.

Further, the Young's modulus or the bending elastic modulus of the soft resin layer 48 can be adjusted by selection or the like of the material of the soft resin layer 48, and thereby the balance can be adjusted between the magnitude of the amplitude of vibration in the vibrating body 3 and the width of the frequency range in which the stator is in the resonance state. Alternatively, the above balance can also be adjusted by adjusting the thickness or the like of the soft resin layer 48.

In addition, the sliding material 7 includes carbon graphite. As a result, sticking can be prevented as in the first embodiment.

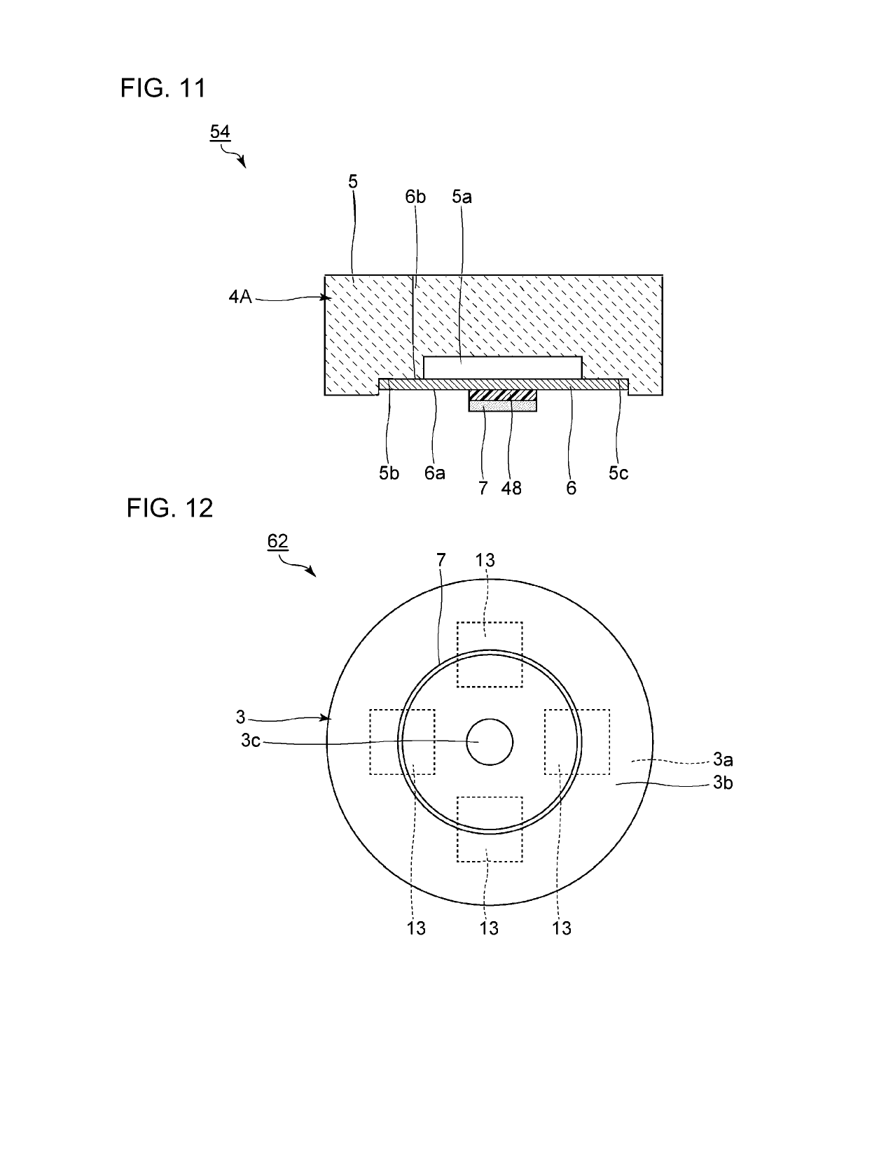

However, also when the soft resin layer 48 is provided, the leaf spring portion 6 illustrated in FIG. 4 may be provided. For example, in a modification of the fourth embodiment illustrated in FIG. 11, the rotor base portion 5 in the rotor main body 4A has a recessed portion 5a. The leaf spring portion 6 is provided on the rotor base portion 5 so as to cover the recessed portion 5a. The soft resin layer 48 is provided between the leaf spring portion 6 and the sliding material 7. In other words, the sliding material 7 is indirectly provided on the leaf spring portion 6 with the soft resin layer 48 interposed therebetween. In other words, the leaf spring portion 6, the soft resin layer 48, and the sliding material 7 are laminated in this order.

The entire sliding material 7 is included within the recessed portion 5a of the rotor base portion 5 in plan view. The width of the sliding material 7 is narrower than the width of the leaf spring portion 6 and the width of the recessed portion 5a.

The rotor 54 is used together with a stator having a vibrating body for an ultrasonic motor. The leaf spring portion 6 and soft resin layer 48 elastically deform following the displacement of the vibrating body due to the traveling wave. As the soft resin layer 48 is elastically deformed, the sliding material 7 is also elastically deformed. As a result, when a traveling wave is generated, the part of the wave head in the vibrating body and the peripheral part thereof can be more reliably brought into contact with the sliding material 7. This makes it possible to more reliably increase the area of contact between the largely displaced part of the vibrating body and the sliding material 7 in the rotor 54. Therefore, the frictional force can be increased between the vibrating body and the rotor 54, and the rotor 54 can be more reliably and efficiently rotated.

As in the fourth embodiment, if the vibration of the stator varies due to the damping effect, the rotor 54 can be suitably rotated, and the ultrasonic motor can be suitably driven. The Young's modulus or the bending elastic modulus of the soft resin layer 48 can be adjusted by selection or the like of the material of the soft resin layer 48, and thereby the balance can also be adjusted between the magnitude of the amplitude of vibration in the vibrating body of the stator and the width of the frequency range in which the stator is in the resonance state. Alternatively, the above balance can also be adjusted by adjusting the thickness or the like of the soft resin layer 48.

The energy of vibration in the stator is also absorbed with elastic deformation of leaf spring portion 6 following displacement of the vibrating body in the stator. The degree of elastic deformation of leaf spring portion 6 can be adjusted by selecting the material of the leaf spring portion 6, adjusting the thickness of the leaf spring portion 6 or the width of recessed portion 5a of rotor base portion 5, or the like. This makes it possible to adjust the amount of vibration energy absorbed in the stator as the leaf spring portion 6 elastically deforms.

Also in the present modification, the sliding material 7 includes carbon graphite. As a result, sticking can be prevented as in the fourth embodiment.

The rotor 54 may include a plurality of sliding materials 27 in the second embodiment illustrated in FIG. 6 or a sliding material 37 in the third embodiment illustrated in FIG. 7, instead of the sliding material 7. In these cases, the rotor 54 can have a lower rigidity in the circling direction of the traveling wave generated in the stator used together with the rotor 54. As a result, similarly to the second embodiment and the third embodiment, the frictional force can be increased between the vibrating body of the stator and the rotor 54, and the rotor 54 can be more reliably and efficiently rotated.

Similarly, the rotor 44 of the fourth embodiment may include a plurality of sliding materials 27 in the second embodiment illustrated in FIG. 6 or a sliding material 37 in the third embodiment illustrated in FIG. 7, instead of the sliding material 7. In these cases, the rotor 44 can have a lower rigidity in the circling direction of the traveling wave generated in the stator used together with the rotor 44. As a result, similarly to the second embodiment and the third embodiment, the frictional force can be increased between the vibrating body of the stator and the rotor 44, and the rotor 44 can be more reliably and efficiently rotated.

FIG. 12 is a schematic bottom view of a stator according to a fifth embodiment of the present disclosure.

The stator 62 of the present embodiment is different from the stator 2 of the first embodiment in including the sliding material 7. For points other than the above, the stator 62 of the present embodiment has the same configuration as the stator 2 of the first embodiment.

The sliding material 7 is provided on the second main surface 3b of the vibrating body 3 in the stator 62. The sliding material 7 has the same configuration as the sliding material 7 of the rotor 4 in the first embodiment. Specifically, the shape of the sliding material 7 in the present embodiment is a circular shape in plan view. The sliding material 7 includes carbon graphite.

The sliding material 7 is provided so as to surround the through hole 3c of the vibrating body 3 in the stator 62. The stator 62 is used together with a rotor in an ultrasonic motor. The sliding material 7 in the stator 62 is a member in contact with the rotor. When the ultrasonic motor is driven, the surface of the rotor slides on the sliding material 7. Therefore, when the ultrasonic motor is driven, the sliding material 7 in the stator 62 relatively slides on the surface of the rotor.

The configuration of the rotor used together with the stator 62 is not particularly limited. It is sufficient that the resin is not used as the material of the portion of the rotor in contact with the sliding material 7.

In driving the ultrasonic motor using the stator 62 of the present embodiment, if abrasion powder is generated from the sliding material 7 made of carbon graphite, a water-soluble component is not generated that functions as an adhesive. Therefore, also in an environment in which the humidity is high and the rotor and the stator 62 are exposed to moisture, the portion of the ultrasonic motor where the rotor and the stator 62 are in contact with each other is less likely to be solidified. This makes it possible to prevent sticking. As a result, the ultrasonic motor can be suitably used also in a severe environment with high humidity.

Note that the stator 62 may include, for example, a plurality of sliding materials 27 in the second embodiment illustrated in FIG. 6 and a sliding material 37 in the third embodiment illustrated in FIG. 7, instead of the sliding material 7. Alternatively, the stator 62 may include, for example, a sliding material 37A in a modification of the third embodiment illustrated in FIG. 8, instead of the sliding material 7.

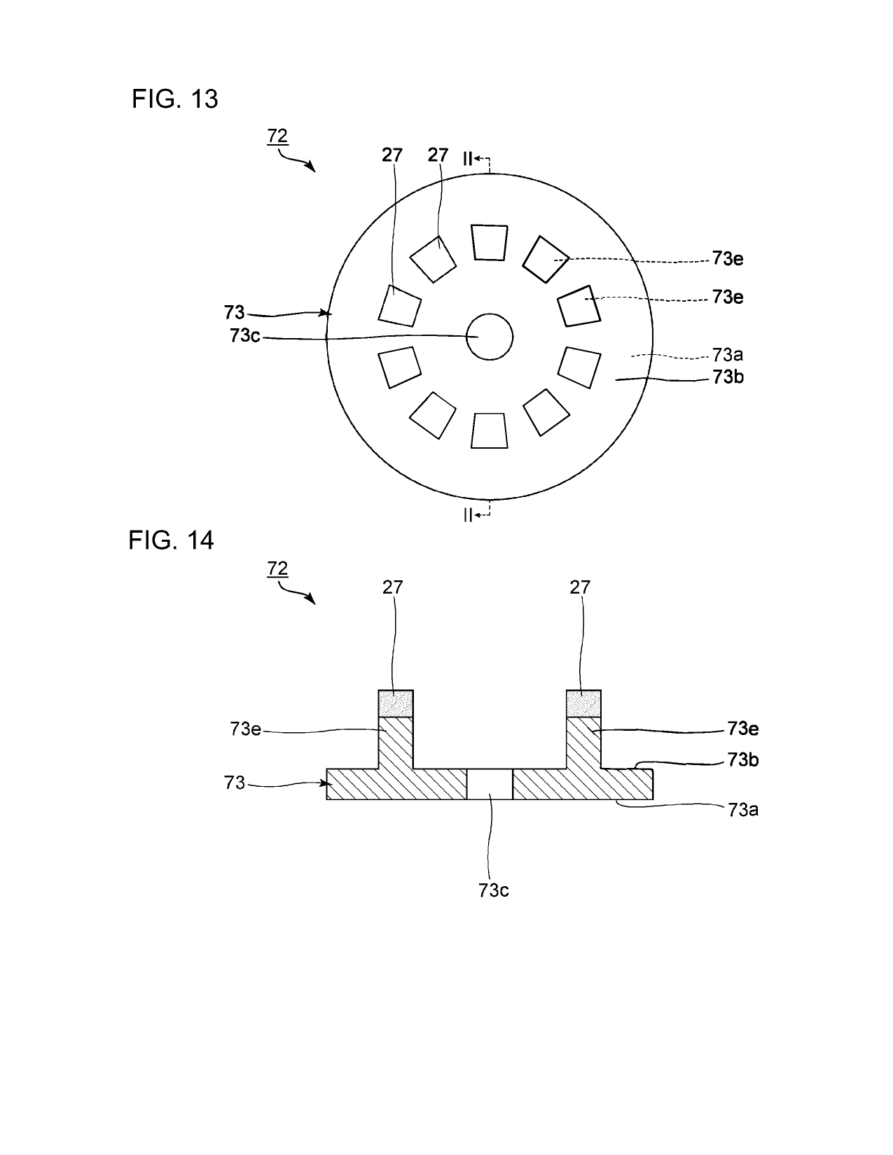

FIG. 13 is a schematic bottom view of a stator according to a sixth embodiment. FIG. 14 is a schematic sectional view taken along line II-II in FIG. 13. In FIGS. 13 and 14, the piezoelectric elements are omitted.

As illustrated in FIGS. 13 and 14, the present embodiment is different from the fifth embodiment in that a plurality of projecting portions 73e are provided on a second main surface 73b of a vibrating body 73. The present embodiment is also different from the fifth embodiment in that a plurality of sliding materials 27 are provided. For points other than the above, the stator 72 of the present embodiment has the same configuration as the stator 62 of the fifth embodiment. Thus, vibrating body 73 has the first main surface 73a and the second main surface 73b, and the vibrating body 73 is provided with a through hole 73c.

As described above, the piezoelectric elements are omitted in FIGS. 13 and 14. However, in the present embodiment, similarly to the fifth embodiment, a plurality of piezoelectric elements are provided on the first main surface 73a of the vibrating body 73.

The second main surface 73b of the vibrating body 73 is provided with the plurality of projecting portions 73e so as to surround the through hole 73c. The plurality of projecting portions 73e are dispersedly disposed on an annular track. Specifically, the annular track is a circular track. In other words, the plurality of projecting portions 73e are dispersedly disposed in the circling direction of the traveling wave generated in the stator 72.

The plurality of projecting portions 73e protrude outward in the axial direction Z from the second main surface 73b of the vibrating body 73. When the stator 72 is used together with the rotor in the ultrasonic motor, the plurality of projecting portions 73e protrude toward the rotor.

One sliding material 27 is provided on each of the plurality of projecting portions 73e. Therefore, similarly to the plurality of projecting portions 73e, the plurality of sliding materials 27 are dispersedly disposed in the circling direction of the traveling wave generated in the stator 72. The plurality of sliding materials 27 come into contact with the rotor.

The plurality of sliding materials 27 includes carbon graphite. Accordingly, also in the present embodiment, the sticking can be prevented similarly to the fifth embodiment.

In addition, in the present embodiment, the plurality of projecting portions 73e protrude outward in the axial direction Z from the second main surface 73b. As a result, when a traveling wave is generated in the vibrating body 73 of the stator 72, the head end portions of the plurality of projecting portions 73e are displaced more largely. Then, the rotor comes into contact with the sliding materials 27 each provided on the surface of the head end portion of the projecting portion 73e in the second main surface 73b. Therefore, the rotor can be efficiently rotated by the traveling wave generated in the stator 72.

Specifically, the displacement of the traveling wave generated in the stator 72 is displacement due to deflection deformation of the vibrating body 73. The displacement due to the deflection deformation is displacement in a direction parallel to the axial direction Z. Therefore, when a traveling wave is generated, deflection deformation is generated on the first main surface 73a and the second main surface 73b of the vibrating body 73. As described above, the head end portions of the plurality of projecting portions 73e provided on the second main surface 73b are displaced more largely.

However, the deflection deformation is not likely to be generated on the surface of the head end portion of each of the projecting portions 73e each provided with a sliding material 27. Therefore, in the plurality of sliding materials 27, deflection deformation is not likely to be generated. This reduces energy loss of the stator 72 due to the deflection deformation of the plurality of sliding materials 27. Accordingly, the ultrasonic motor can be efficiently driven.

In addition, in each sliding material 27 made of carbon graphite, there is a concern that cracking occurs due to excessive deflection deformation. In contrast, in the present embodiment, deflection deformation is not likely to be generated in each sliding material 27. Therefore, cracking in each sliding material 27 can be more reliably prevented.

The ultrasonic motor according to the present disclosure only needs to include, for example, the rotor according to the present disclosure and an appropriate stator. Alternatively, the ultrasonic motor according to the present disclosure only needs to have an appropriate rotor and the stator according to the present disclosure. These make it possible to prevent sticking.

### DESCRIPTION OF REFERENCE SYMBOLS

1: Ultrasonic motor

2: Stator

3: Vibrating body

3a, 3b: First and second main surfaces

3c: Through hole

3d: Contact surface

4: Rotor

4A: Rotor main body

4c: Through hole

5: Rotor base portion

5a: Recessed portion

5b, 5c: Groove portion

6: Leaf spring portion

6a, 6b: First and second surfaces

7: Sliding material

8: First case member

8a, 8b: First and second cylindrical protruding portions

8c: Through hole

9: Second case member

9a: Cylindrical protruding portion

9c: Through hole

10: Shaft member

10a: Wide portion

12: Elastic member

13: Piezoelectric element

14: Piezoelectric body

14a, 14b: Third and fourth main surfaces

15A, 15B: First and second electrodes

16: Spring member

16c: Through hole

17: Snap ring

18, 19: First and second bearing portions

24: Rotor

27: Sliding material

34: Rotor

37, 37A: Sliding material

37a: Protruding portion

37b: Non-protruding portion

44: Rotor

44A: Rotor main body

48: Soft resin layer

54: Rotor

62, 72: Stator

73: Vibrating body

73a, 73b: First and second main surfaces

73c: Through hole

73e: Projecting portion

1. A rotor for an ultrasonic motor, the rotor comprising:
a rotor main body; and
a sliding material on the rotor main body and positioned for contact with a vibrating body of a stator,
wherein the sliding material includes carbon graphite.

2. The rotor according to claim 1, wherein
the carbon graphite has a graphitization degree R of 0.5 to 1.2, and
the graphitization degree R of the carbon graphite is expressed by R = D/G,
where D is a peak value of a D band, and G is a peak value of a G band, each band being in a Raman spectrum of the carbon graphite in the sliding material, the Raman spectrum being obtained by Raman spectroscopy in which a wavelength of incident laser light is 532 nm and a grating type is 600 gr/m.

3. The rotor according to claim 1, wherein
the rotor main body includes a rotor base portion having a recessed portion, and a leaf spring portion on the rotor base portion that covers the recessed portion, and
the sliding material is on the leaf spring portion.

4. The rotor according to claim 3, further comprising a soft resin layer between the leaf spring portion and the sliding material.

5. The rotor according to claim 1, further comprising a soft resin layer between the rotor main body and the sliding material.

6. The rotor according to claim 5, further comprising a plurality of the sliding materials, and wherein the plurality of sliding materials are dispersedly disposed in an annular track on the rotor main body in a plan view of the rotor.

7. The rotor according to claim 3, further comprising a plurality of the sliding materials, and wherein the plurality of sliding materials are dispersedly disposed in an annular track on the rotor main body in a plan view of the rotor.

8. The rotor according to claim 4, further comprising a plurality of the sliding materials, and wherein the plurality of sliding materials are dispersedly disposed in an annular track on the rotor main body in a plan view of the rotor.

9. The rotor according to claim 1, further comprising a plurality of the sliding materials, and wherein the plurality of sliding materials are dispersedly disposed in an annular track on the rotor main body in a plan view of the rotor.

10. The rotor according to claim 1, wherein the sliding material includes a plurality of protruding portions dispersedly disposed on an annular track on the rotor main body in a plan view of the rotor, and the plurality of protruding portions protrude toward the vibrating body.

11. A stator for an ultrasonic motor, the stator comprising:
a vibrating body;
a vibration generating element on the vibrating body; and
a sliding material on the vibrating body and positioned for contact with a rotor,
wherein the sliding material includes carbon graphite.

12. The stator according to claim 11, wherein
the carbon graphite has a graphitization degree R of 0.5 to 1.2, and
the graphitization degree R of the carbon graphite is expressed by R = D/G,
where D is a peak value of a D band, and G is a peak value of a G band, each band being in a Raman spectrum of the carbon graphite used for the sliding material, the Raman spectrum being obtained by Raman spectroscopy in which a wavelength of incident laser light is 532 nm and a grating type is 600 gr/m.

13. The stator according to claim 11, further comprising a plurality of the sliding materials, and wherein the plurality of sliding materials are dispersedly disposed in an annular track on the vibrating body in a plan view of the stator.

14. The stator according to claim 13, wherein the vibrating body includes a plurality of protruding portions dispersedly disposed on the annular track, and the plurality of protruding portions protrude toward the rotor and a respective sliding material of the plurality of the sliding materials is on each of the plurality of protruding portions.

15. An ultrasonic motor comprising:
the rotor according to claim 1; and
a stator including the vibrating body and a vibration generating element on the vibrating body.

16. An ultrasonic motor comprising:
the stator according to claim 11; and
a rotor.
